(19) United States
(12) Patent Application Publication
(10) Pub. No.: US 2007/0058910 A1
(43) Pub. Date: Mar. 15, 2007

(54) Light transmitting/receiving element, bidirectional light transmitting/receiving system having the light transmitting/receiving element, and optical sensor

(75) Inventor: Tomoki Umezawa, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/399,386

(22) Filed: Apr. 7, 2006

(30) Foreign Application Priority Data
Sep. 15, 2005 (JP) 2005-268733

(51) Int. Cl. G02B 6/36

(52) U.S. Cl. 385/89; 385/14

(57) ABSTRACT

A light transmitting/receiving element includes a first base member, a second base member, an exiting window, and a transmitting portion. A surface light-emitting element is formed on a top surface of the first base member. The second base member is provided on the first base member, and a light-receiving element is formed on a top surface of the second base member. The exiting window is provided at the light-receiving element. Light, which the surface light-emitting element emits, exits from the exiting window. The transmitting portion is provided between the exiting window and the surface light-emitting element, and the light passes through the transmitting portion.

### CROSS-REFERENCE TO RELATED APPLICATION

This application claims priority under 35 USC 119 from Japanese Patent Application No. 2005-268733, the disclosure of which is incorporated by reference herein.

### BACKGROUND

1. Technical Field

The present invention relates to a light transmitting/receiving element, a bidirectional light transmitting/receiving system having the light transmitting/receiving element, and an optical sensor.

2. Related Art

A surface light-emitting element and a light-receiving element are separately built-into a light transmitting/receiving device which is mounted to both end portions of an optical fiber used in a bidirectional light transmitting/receiving system. Light must be guided from the surface light-emitting element and the light-receiving element, which are disposed at different positions, to the optical fiber by using reflection or collection/refraction or the like, and the structure is complex. Therefore, highly-precise positional adjustment is needed, and the manufacturing process is complicated and not easy. Moreover, there are limits to making the structure compact.

Similarly, in an optical sensor in which a surface light-emitting element and a light-receiving element are built-in separately, highly-precise positional adjustment is needed, and the assembly process is complex. Further, there are limits to making the structure compact.

Thus, structures in which the light-emitting element and the light-receiving element are made integral have been proposed.

### SUMMARY

According to an aspect of the present invention, a light transmitting/receiving (transmitting and receiving) element includes: a first base member on whose top surface a surface light-emitting element is formed; a second base member which is provided on the first base member, and on whose top surface a light-receiving element is formed; an exiting window which is provided at the light-receiving element, and from which light, which the surface light-emitting element emits, exits; and a transmitting portion provided between the exiting window and the surface light-emitting element, the light passing through the transmitting portion.

### BRIEF DESCRIPTION OF THE DRAWINGS

Embodiments of the present invention will be described in detail based on the following figures, wherein:

FIG. 1A is a vertical sectional view schematically showing a light transmitting/receiving element used in a bidirectional light transmitting/receiving system of a first exemplary embodiment of the present invention;

FIG. 1B is a top view schematically showing the light transmitting/receiving element used in the bidirectional light transmitting/receiving system of the first exemplary embodiment of the present invention;

FIG. 2 is a sectional view schematically showing the bidirectional light transmitting/receiving system of the first exemplary embodiment of the present invention;

FIG. 3A is an explanatory diagram schematically showing the bidirectional light transmitting/receiving system of the first exemplary embodiment of the present invention, and explaining a refractive index of an optical fiber;

FIG. 3B is a sectional view schematically showing the bidirectional light transmitting/receiving system of the first exemplary embodiment of the present invention, and explaining the refractive index of the optical fiber;

FIG. 3C is a graph schematically showing the bidirectional light transmitting/receiving system of the first exemplary embodiment of the present invention, and showing an intensity distribution of laser light;

FIG. 3D is a vertical sectional view schematically showing the bidirectional light transmitting/receiving system of the first exemplary embodiment of the present invention, and schematically showing the light transmitting/receiving element;

FIG. 3E is a top view schematically showing the bidirectional light transmitting/receiving system of the first exemplary embodiment of the present invention, and schematically showing the light transmitting/receiving element;

FIG. 4A is a vertical sectional view schematically showing a state in which an external substrate is joined to the light transmitting/receiving element;

FIG. 4B is a top view schematically showing the state in which the external substrate is joined to the light transmitting/receiving element;

FIG. 5 is a schematic diagram showing a state of producing the light transmitting/receiving element by joining a first base member and a second base member;

FIG. 6 schematically illustrates a state in which an external substrate is joined to a light transmitting/receiving element of another structure, where upper is a vertical sectional view and lower is a top view;

FIG. 7 schematically illustrates a state in which an external substrate is joined to a light transmitting/receiving element of yet another structure, where upper is a vertical sectional view and lower is a top view;

FIG. 8 is a sectional view schematically showing a state in which laser light is reflected at an end surface of the optical fiber, when there is a space between the optical fiber and the light transmitting/receiving element in the bidirectional light transmitting/receiving system of the first exemplary embodiment of the present invention;

FIG. 9A is a graph schematically showing a bidirectional light transmitting/receiving system of a second exemplary embodiment of the present invention, and showing an intensity distribution of laser light;

FIG. 9B is a vertical sectional view schematically showing the bidirectional light transmitting/receiving system of the second exemplary embodiment of the present invention, and schematically showing a light transmitting/receiving element;

FIG. 9C is a top view schematically showing the bidirectional light transmitting/receiving system of the second exemplary embodiment of the present invention, and schematically showing the light transmitting/receiving element;

FIG. 10 is a sectional view schematically showing the bidirectional light transmitting/receiving system of the second exemplary embodiment of the present invention;

FIG. 11 is a sectional view schematically showing a state in which a light-receiving element does not receive reflected laser light even if there is a space between an optical fiber and the light transmitting/receiving element, in the bidirectional light transmitting/receiving system of the second exemplary embodiment of the present invention;

FIG. 12 is a sectional view schematically showing an optical sensor of the present invention;

FIG. 13A is a vertical sectional view schematically showing a first modified example of the light transmitting/receiving element;

FIG. 13B is a top view schematically showing the first modified example of the light transmitting/receiving element;

FIG. 14A is a schematic diagram schematically showing a second modified example of a light transmitting/receiving device, and showing a state of joining a first base member and a second base member;

FIG. 14B is a sectional view schematically showing the second modified example of the light transmitting/receiving device, after joining; and

FIG. 15 is a diagram showing an optical sensor of the related art.

### DETAILED DESCRIPTION OF THE INVENTION

First, a light transmitting/receiving system of a first exemplary embodiment of the present invention will be described.

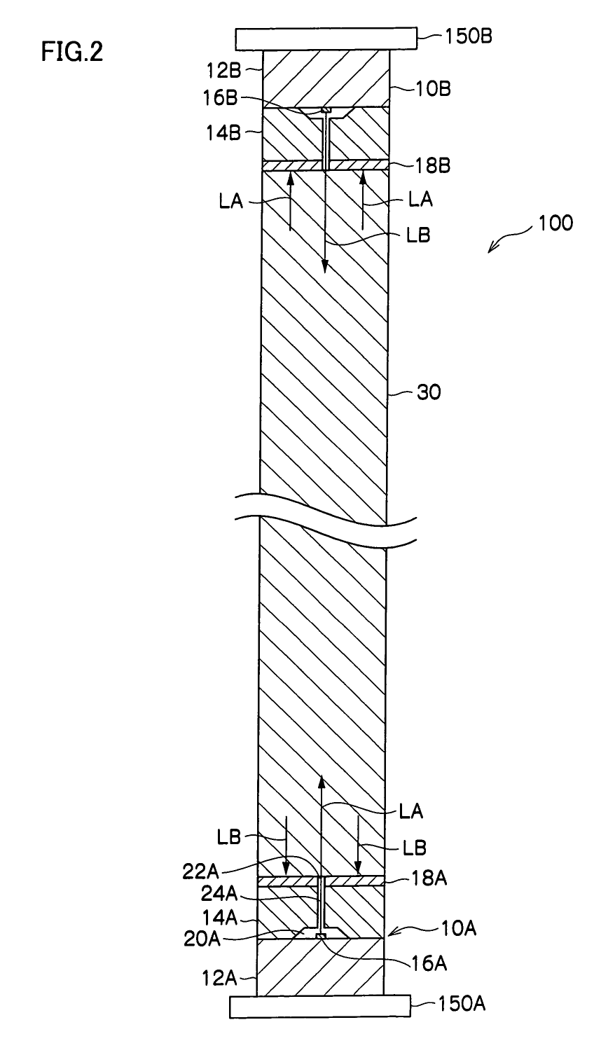

As shown in FIG. 2, in a bidirectional light transmitting/receiving system 100, a light transmitting/receiving element 10A is joined to one end portion of an optical fiber 30, and a light transmitting/receiving element 10B is joined to the other end portion. Note that the letter A is added after the reference numeral of the light transmitting/receiving element which is joined to the one end, such that it is called the light transmitting/receiving element 10A. Similarly, at the other side as well, the letter B is added such that it is called a light transmitting/receiving element 10B. With regard to the other members as well, A and B are similarly added after the reference numerals, such as surface light-emitting element 16A, light-receiving element 18B, laser light LA. Note that, when there is no need to distinguish between the one side and the other side, the letters A and B are omitted.

The bidirectional light transmitting/receiving system 100 carries out optical communication by guiding laser light L, which exits from the light transmitting/receiving element 10, to the optical fiber 30 on the basis of electric signals from a computer or the like.

The optical fiber 30 is a communication cable structured by thin fibers which are formed from glass or plastic or the like through which the laser light L passes. Note that extremely high-purity glass or plastic or the like is used at the optical fiber 30, such that the laser light L passes through smoothly. Note that, in the present invention, explanation will be given by using the example of an optical fiber, but instead of an optical fiber, an optical waveguide may be used.

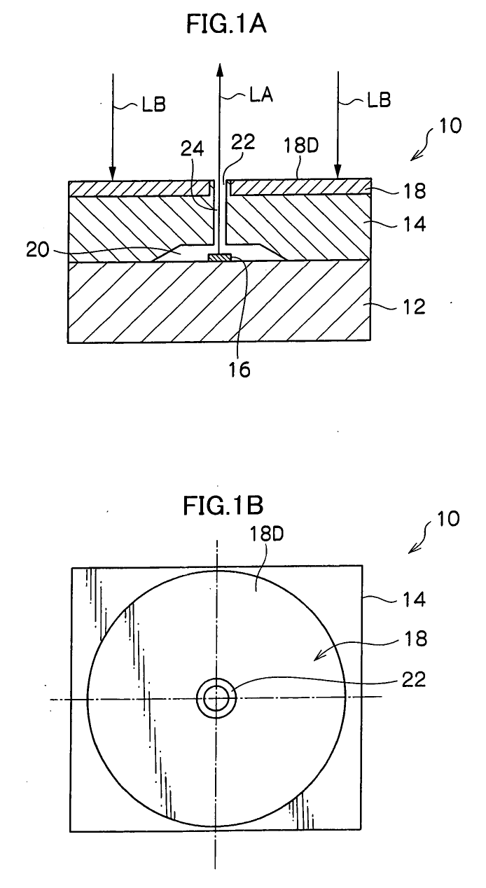

As shown in FIGS. 1A and 1B, the light transmitting/receiving element 10 is a structure in which a second base member 14 is laminated on and joined to a first base member 12.

A surface light-emitting element 16 is formed on the top surface of the first base member 12 (the surface which is joined to the second base member 14). The surface light-emitting element 16 is a surface light-emitting laser (VCSEL: Vertical Cavity Surface Emitting Laser) in which plural light-emitting points which emit the laser light L are arranged two-dimensionally. A planar light-receiving element 18 is formed on the top surface of the second base member 14.

A recess 20, in which the surface light-emitting element 16 is accommodated, is formed in the bottom surface of the second base member 14 (the surface which is joined to the first base member 12). Further, an exiting window 22, from which the laser light L which the surface light-emitting element 16 emits can exit, is formed in the second base member 14. A cylindrical cavity 24, which is such that the region between the exiting window 22 and the surface light-emitting element 16 is hollow, is formed in the second base member 14.

Accordingly, the laser light L, which the surface light-emitting element 16 emits, passes through the cavity 24 and exits from the exiting window 22. As shown in FIG. 1B, the exiting window 22 is positioned at the substantial center of the top surface of the planar light-receiving element 18, i.e., a light-receiving surface 18D.

Because the light-receiving element 18 is provided above and made integral with the surface light-emitting element 16, the light transmitting/receiving element 10 can be made to be compact.

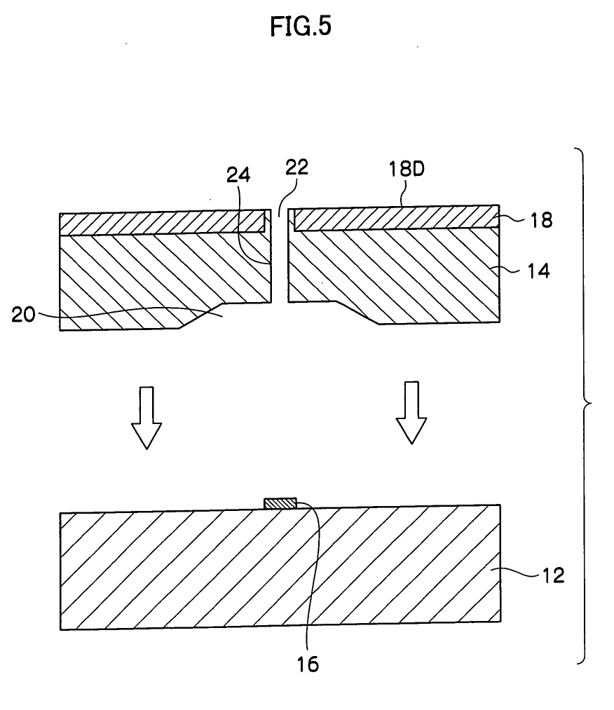

Because such a structure is employed, as shown in FIG. 5, the first base member 12 at which the surface light-emitting element 16 is formed, and the second base member 14, at which the light-receiving element 18 is formed, are produced separately, and after being produced, are laminated and joined together. Manufacturing can thereby be made easy. Further, optimal materials can be selected for each of the first base member 12 and the second base member 14. Different materials can be used at the first base member 12 and the second base member 14, such as, for example, a GaAs material which is suitable for forming the surface light-emitting element 16 is used as the first base member 12, and an Si material which is suitable for forming the light-receiving element 18 is used as the second base member 14, or the like. Further, if the first base member 12 and the second base member 14 are made integral at the semiconductor wafer level, mass-produceability is further improved.

As shown in FIG. 2 and as mentioned previously, at the bidirectional light transmitting/receiving system 100, the light transmitting/receiving element 10A is joined by a transparent adhesive or the like to the one end portion of the optical fiber 30, and the light transmitting/receiving element 10B is joined to the other end portion. The surface of the light transmitting/receiving element 10 which is joined to the optical fiber 30 is the light-receiving surface 18D of the light-receiving element 18 of the second base member 14. Note that, because the light-receiving element 18 is provided above and made integral with the surface light-emitting element 16, the step of joining the light transmitting/receiving element 10 to the optical fiber 30 also is easy.

As shown in FIG. 2, the laser light LA, which exits from the light transmitting/receiving element 10A joined to the one end portion of the optical fiber 30, is guided through the optical fiber 30, and is received at the light-receiving element 18B of the light transmitting/receiving element 10B which is joined to the other end portion. Similarly, laser light LB, which exits from the light transmitting/receiving element 10B joined to the other end portion of the optical fiber 30, is guided through the optical fiber 30, and is received at a light-receiving element 18A of the light transmitting/receiving element 10A which is joined to the one end portion. Optical communication is carried out in both directions due to the laser lights LA, LB being transmitted and received.

The wavelength of the laser light LA exiting from the light transmitting/receiving element 10A, and the wavelength of the light which can be received at the light transmitting/receiving element 10A, are different. Similarly, the wavelength of the laser light LB exiting from the light transmitting/receiving element 10B, and the wavelength of the light which can be received at the light transmitting/receiving element 10B, are different.

Further, the wavelength of the exiting laser light LA of the light transmitting/receiving element 10A mounted to the one end portion of the optical fiber 30, and the wavelength which is received by the light transmitting/receiving element 10B mounted to the other end portion, are the same. Similarly, the wavelength of the exiting laser light LB of the light transmitting/receiving element 10B mounted to the other end portion of the optical fiber 30, and the wavelength which is received by the light transmitting/receiving element 10A mounted to the one end portion, are the same.

Namely, the wavelength of the exiting laser light LA of the one light transmitting/receiving element 10A is a wavelength which cannot be received at the light transmitting/receiving element 10A itself, but is a wavelength which can be received at the other light transmitting/receiving element 10B. Similarly, the wavelength of the exiting laser light LB of the other light transmitting/receiving element 10B is a wavelength which cannot be received at the light transmitting/receiving element 10B itself, but is a wavelength which can be received at the one light transmitting/receiving element 10A.

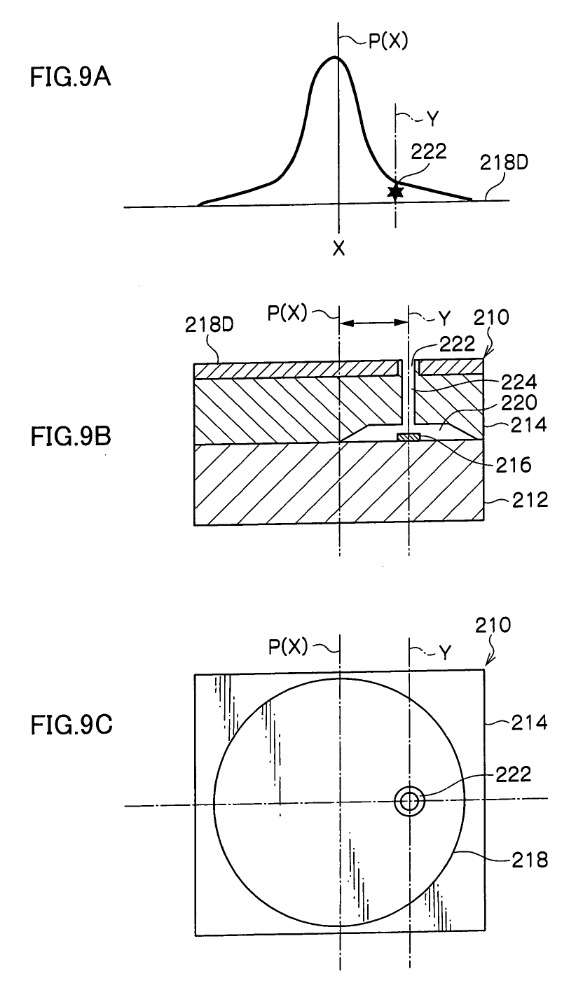

When the refractive index of the cross-section of an optical fiber is symmetrical with respect to the central position, the intensity distribution of the laser light L at the light-receiving surface 18D of the light-receiving element 18 is such that the intensity is strongest at the central position, and weakens toward the peripheral portions. Namely, the central position is the peak position of the intensity distribution of the laser light L (see FIG. 9A).

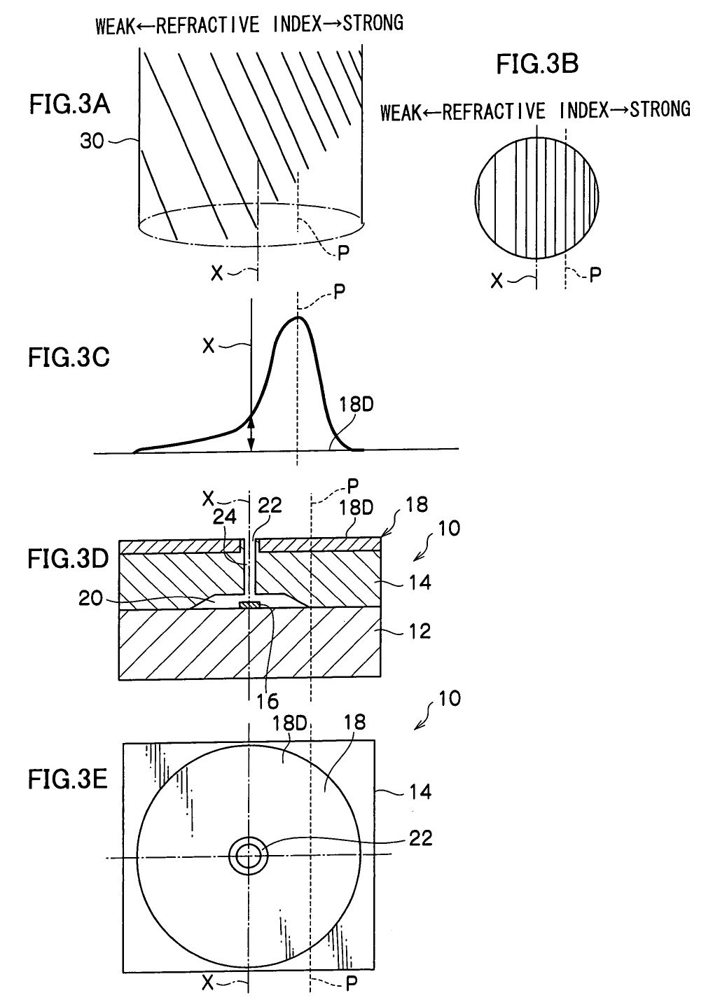

In contrast, in this exemplary embodiment, as shown in FIGS. 3A and 3B, the refractive index of the cross-section of the optical fiber 30 is asymmetrical with respect to a central position X. Therefore, as shown in FIG. 3C, a peak position P of the intensity distribution of the laser light L at the light-receiving surface 18D of the light-receiving element 18, is offset from the central position X. Namely, as shown in FIGS. 3C to FIG. 3E, the exiting window 22 which is at the central position X of the light-receiving surface 18D, and the peak position P of the intensity of the laser light L, do not overlap one another.

Next, the connecting of the light transmitting/receiving element 10 and an external substrate 150 will be described.

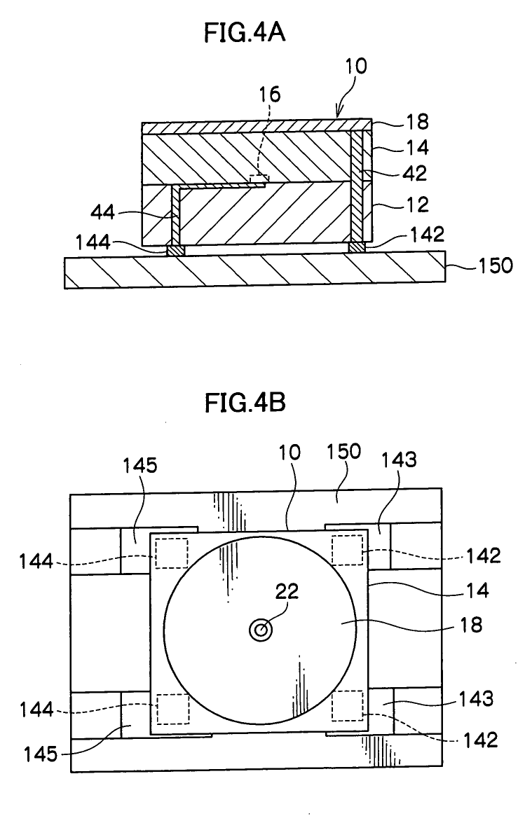

As shown in FIGS. 4A and 4B, the light-receiving element 18 is, via pass-through portions 42 which pass through the first base member 12 and the second base member 14, electrically connected to external electrodes 142 which are exposed at the bottom surface of the light transmitting/receiving element 10. The surface light-emitting element 16 is, via pass-through portions 44 which pass through the first base member 12, electrically connected to external electrodes 144 which are exposed at the bottom surface of the light transmitting/receiving element 10.

There are two of each of the external electrodes 142, 144, and, as seen in plan view from above, the external electrodes 142, 144 are positioned at the four corners of the bottom surface of the light transmitting/receiving element 10. The center of the light transmitting/receiving element 10 is positioned within the region surrounded by the external electrodes 142, 144 at the four corners.

Lands 143, 145 of the external substrate 150, and the external electrodes 142, 144 which are exposed at the bottom surface of the light transmitting/receiving element 10, are joined together.

Operation of this exemplary embodiment will be described next.

As shown in FIGS. 1A and 1B as well as in FIGS. 2 and 5, the first base member 12 on which the surface light-emitting element 16 is formed, and the second base member 14 on which the light-receiving element 18 is formed, are respectively produced, and after production, are laminated and joined together. Accordingly, optimal materials can be selected for each of the first base member 12 and the second base member 14. Further, the mass produceability also is excellent. In addition, because the planar light-receiving element 18 is provided and made integral above the surface light-emitting element 16, the process of joining the light transmitting/receiving element 10 to the optical fiber 30 also is easy.

As described above, when the refractive index of the cross-section of an optical fiber is symmetrical with respect to the central position, in the intensity distribution of the laser light at the light-receiving surface 18D of the light-receiving element 18, the central position is the strongest and the intensity weakens toward the peripheral portions (see FIG. 9A). Accordingly, because the exiting window 22 portion, which is at the central position of the light-receiving surface 18D, cannot receive light, the light-receiving efficiency is poor.

Accordingly, in this exemplary embodiment, as shown in FIGS. 3A through 3E, by making the refractive index of the cross-section of the optical fiber 30 asymmetrical with respect to the central position X, the peak position P of the intensity distribution of the laser light L at the light-receiving surface 18D of the light-receiving element 18 is offset from the central position X. With such a structure, the peak position P and the exiting window 22, which is at the central position X, do not overlap, and therefore, the light-receiving efficiency is good.

Note that an optical fiber, in which the refractive index of the cross-section is symmetrical with respect to the central position, may be used, although the light-receiving efficiency deteriorates.

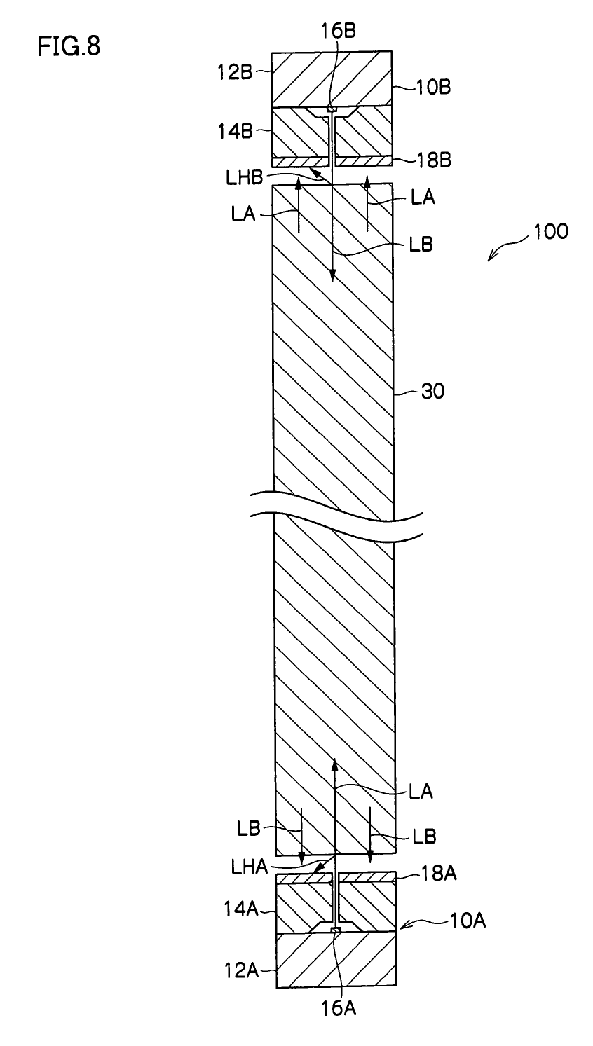

Further, as shown in FIG. 8, when there is a space at the joined-together portion of the light transmitting/receiving element 10 and the optical fiber 30, a portion of the exiting laser light L is reflected at the end surface of the optical fiber 30. When the light-receiving element 18 receives reflected laser light LH, it becomes noise. Note that the space is drawn large in FIG. 8 for easy understanding.

However, in this exemplary embodiment, the wavelength of the laser light LA, which exits from the surface light-emitting element 16A of the light transmitting/receiving element 10A joined to the one end portion of the optical fiber 30, and the wavelength of the laser light LB, which the light-receiving element 18A can receive, are different. Accordingly, because the light-receiving element 18A cannot receive reflected laser light LHA, it does not become noise. Similarly, the wavelength of the laser light LB, which exits from the surface light-emitting element 16B of the light transmitting/receiving element 10B joined to the other end portion of the optical fiber 30, and the wavelength of the laser light LA, which the light-receiving element 18B can receive, are different. Accordingly, because the light-receiving element 18B cannot receive reflected laser light LHB, it does not become noise.

The wavelength of the laser light LA exiting from the one light transmitting/receiving element 10A cannot be received at the light transmitting/receiving element 10A itself, but can be received at the other light transmitting/receiving element 10B. Similarly, the wavelength of the laser light LB exiting from the other light transmitting/receiving element 10B cannot be received at the light transmitting/receiving element 10B itself, but can be received at the one light transmitting/receiving element 10A. Accordingly, bidirectional communication is possible.

Note that the wavelength of the exiting laser light and the wavelength of the received laser light may be the same, although it becomes easy for the structure to be affected by noise when there is a space. Further, if the light transmitting/receiving element 10 and the optical fiber 30 are fit tightly together and adhered together by an adhesive or the like having, for example, a refractive index which is substantially the same as that of the optical fiber 30, reflection at the joined-together surfaces can be greatly decreased.

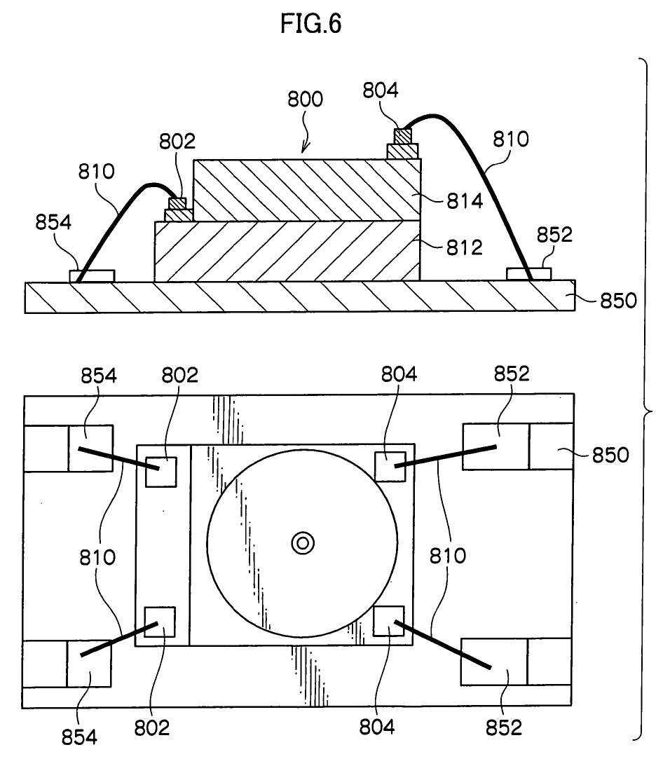

The following structure can be considered for the connecting of a light transmitting/receiving element and an external substrate: as shown in FIG. 6, at a light transmitting/receiving element 800, external electrodes 802, 804 are provided respectively at the top surface of a first base member 812 at which a surface light-emitting element is formed, and at the top surface of a second base member 814 at which a light-receiving element is formed. The external electrodes 802, 804 are connected to lands 852, 854 of an external substrate 850 by wire bondings 810. However, with such a method, the light transmitting/receiving element 800 becomes large. In addition, it is easy for the wire bondings 810 to interfere with the optical fiber.

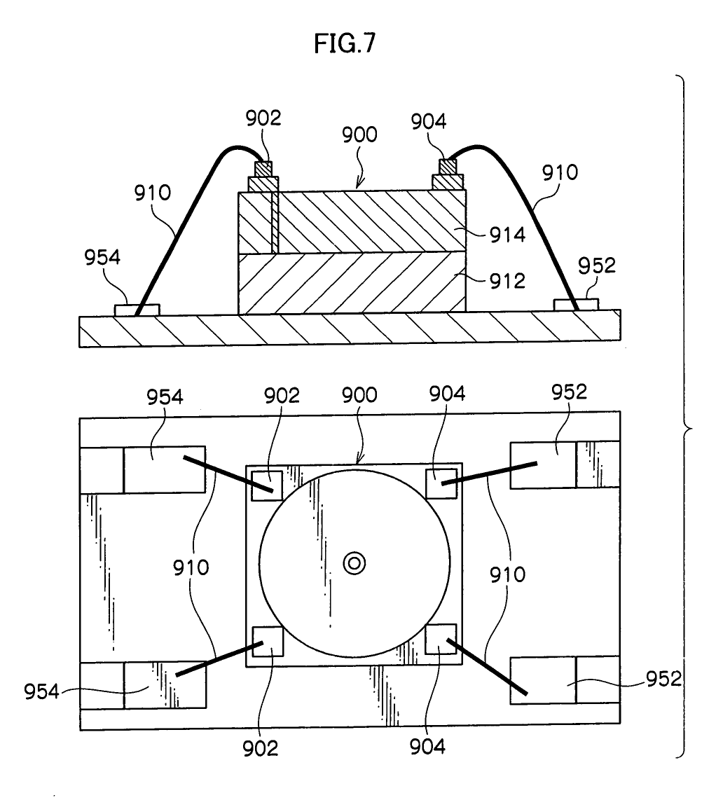

Further, as shown in FIG. 7, when external electrodes 902 of a surface light-emitting element of a first base member 912 pass-through a second base member 914, at which a light-receiving element is formed, and are exposed at the top surface, a light transmitting/receiving element 900 can be made compact. However, it is easy for wire bondings 910, which connect lands 952, 954 and the external electrodes 902, 904, to interfere with the optical fiber.

Thus, in this exemplary embodiment, as shown in FIGS. 4A and 4B, the external electrodes 142, 144 are exposed at the bottom surface of the light transmitting/receiving element 10, and are directly joined to the lands 143, 145 of the external substrate 150. With such a structure, the light transmitting/receiving element 10 can be made to be even more compact. Further, because no wire bondings are used, interference between wire bondings and the optical fiber 30 does not arise. Moreover, because wire bondings are not used, the impedance is low and the high-frequency characteristic improves.

In such a structure in which the lands 143, 145 and the external electrodes 142, 144 are directly joined, a gap corresponding to the height of the external electrodes 142, 144 (or the height of the lands 143, 145) arises between the bottom surface of the light transmitting/receiving element 10 and the top surface of the external substrate 150. However, as shown in FIG. 4B, the external electrodes 142, 144 are positioned at the four corners of the bottom surface as seen in plan view from above, and the center of the light transmitting/receiving element 10 is within the region surrounded by the external electrodes 142, 144 at the four corners thereof. Accordingly, even if a gap arises between the bottom surface of the light transmitting/receiving element 10 and the top surface of the external substrate 150, the light transmitting/receiving element 10 does not tilt and is stable. For example, in a case assuming that there are only the two external electrodes which are at the right side in the drawing, the light transmitting/receiving element is unstable and tilts toward the left.

Note that it is not necessary for there to be four external electrodes. If there are a total of three or more external electrodes and the center of the light transmitting/receiving element is within the region surrounded by these external electrodes, the structure is stable.

Further, the structures of FIGS. 6 and 7 may be used, although there are problems such as it is easy for interference with the optical fiber to arise, and the like. In this case, hardly any gap arises between the bottom surface of the light transmitting/receiving element and the top surface of the external substrate. Therefore, the structure is stable regardless of the number of and the positions of the external electrodes. Accordingly, there is a large number of degrees of freedom in design, such as the arrangement of the external electrodes and the like.

A bidirectional light transmitting/receiving system of a second exemplary embodiment of the present invention will be described next. Description which is repetitive with the first exemplary embodiment will be omitted.

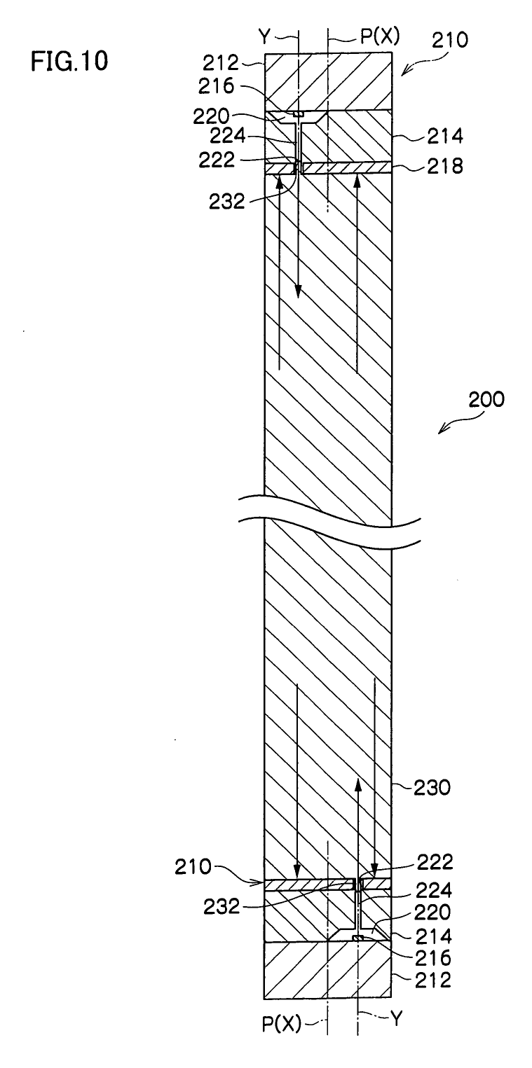

As shown in FIG. 10, a bidirectional light transmitting/receiving system 200 of the second exemplary embodiment as well is structured such that light transmitting/receiving elements 210 are joined to both the one end portion and the other end portion of an optical fiber 230.

As shown in FIGS. 9B and 9C, the light transmitting/receiving element 210 also is structured such that a first base member 212, on whose top surface a surface light-emitting element 216 is formed, and a second base member 214, on whose top surface a planar light-receiving element 218 is formed, are laminated and joined together. A recess 220, which accommodates the surface light-emitting element 216, is formed in the second base member 214. A cavity 224 through which the laser light L passes, and an exiting window 222 from which the laser light L exits, are also formed.

Projecting portions 232 are formed at the both end portions of the optical fiber 230. The projecting portions 232 are fit into the exiting windows 222. The laser light L, which the surface light-emitting element 216 emits, is incident on the optical fiber 230 from the distal end surface of the projecting portion 232.

The refractive index of the cross-section of the optical fiber 230 is symmetrical with respect to the central position. As shown in FIG. 9A, in the intensity distribution of the laser light at a light-receiving surface 218D of the planar light-receiving element 218, the central position X is the strongest and the intensity weakens toward the peripheral portions. Namely, the peak position P is at the central position X.

As shown in FIGS. 9B and 9C, the exiting window 222 of the light transmitting/receiving element 210 is at a position Y which is offset from the central position X of the light-receiving surface 218D of the light-receiving element 218. Namely, the peak position P (central position X) where the intensity of the laser light L is strong, and the exiting window 222 do not overlap.

Note that, in this exemplary embodiment, the wavelengths of the laser lights exiting from and the wavelengths of the lights received at the one and the other light transmitting/receiving elements 210 are the same. Further, because the connection to an external substrate is similar to that in the first exemplary embodiment, description thereof is omitted.

Operation of this exemplary embodiment will be described next.

As shown in FIGS. 9A through 9C, the exiting window 222 of the light transmitting/receiving element 210 is at the position Y which is offset from the central position X of the light-receiving surface 218D of the light-receiving element 218. Namely, the peak position P (central position X) where the intensity of the laser light L is strong, and the exiting window 222 do not overlap. Accordingly, the light-receiving efficiency is good.

Note that the exiting window may be formed at the central position as in the first exemplary embodiment, although the peak position P and the exiting window overlap and the light-receiving efficiency deteriorates.

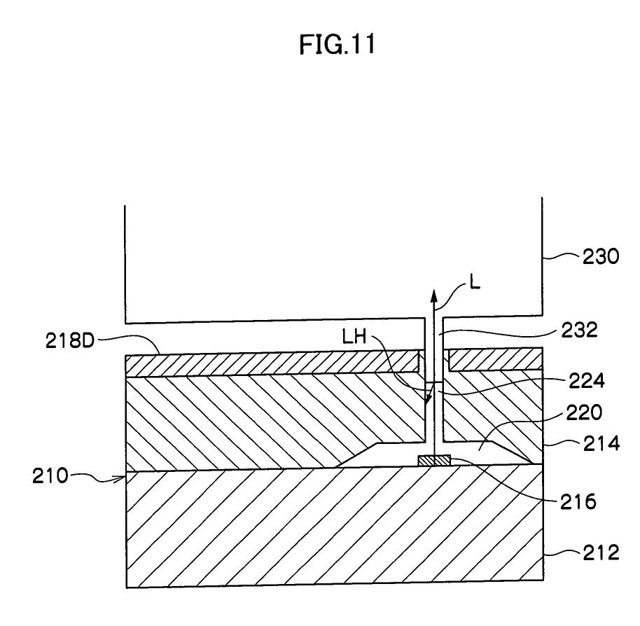

The distal end surface of the projecting portion 232 of the optical fiber 230 is closer to the surface light-emitting element 216 than the light-receiving surface 218D of the light-receiving element 218. Accordingly, as shown in FIG. 11, even if there is a space between the optical fiber 230 and the light transmitting/receiving element 210, the laser light L, which the surface light-emitting element 216 emits, is reflected at the distal end surface of the projecting portion 232. Accordingly, because the light-receiving element 218 does not receive the reflected laser light LH, noise is prevented.

Because noise is prevented as described above, it is not problematic if the wavelengths of the laser light L exiting from and the wavelengths of the light received at the one and the other light transmitting/receiving elements 210 are the same. However, they may be different as in the first exemplary embodiment.

An optical sensor having the light transmitting/receiving element will be described next.

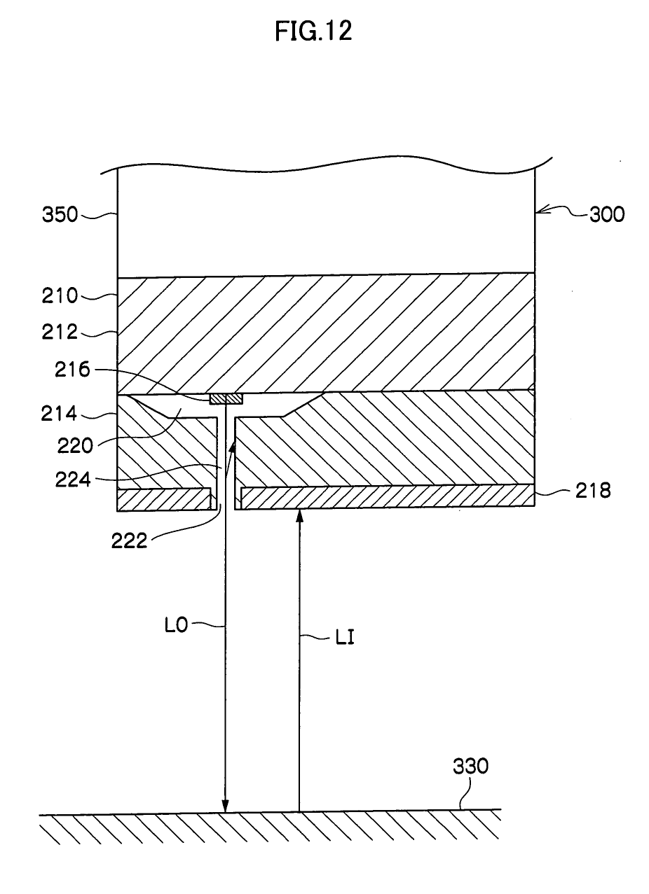

As shown in FIG. 12, an optical sensor 300 has the light transmitting/receiving element 210 described in the second exemplary embodiment. Further, laser light LO which exits is illuminated onto an object of measurement 330, and reflected laser light LI (reflected light) is received. Then, by analyzing and measuring the received laser light LI (the reflected light), the presence/absence of the object of measurement 330 is judged, the distance to the object of measurement is measured, or the like.

Because the light transmitting/receiving element 210 has the same structure as that of the light transmitting/receiving element 210 used in the bidirectional light transmitting/receiving system 200 of the second exemplary embodiment, description thereof will be omitted.

The joining of the light transmitting/receiving element 210 and an external substrate 350 as well is similar to the structure described in the first exemplary embodiment, and therefore, description thereof will be omitted.

Operation of this exemplary embodiment will be described next.

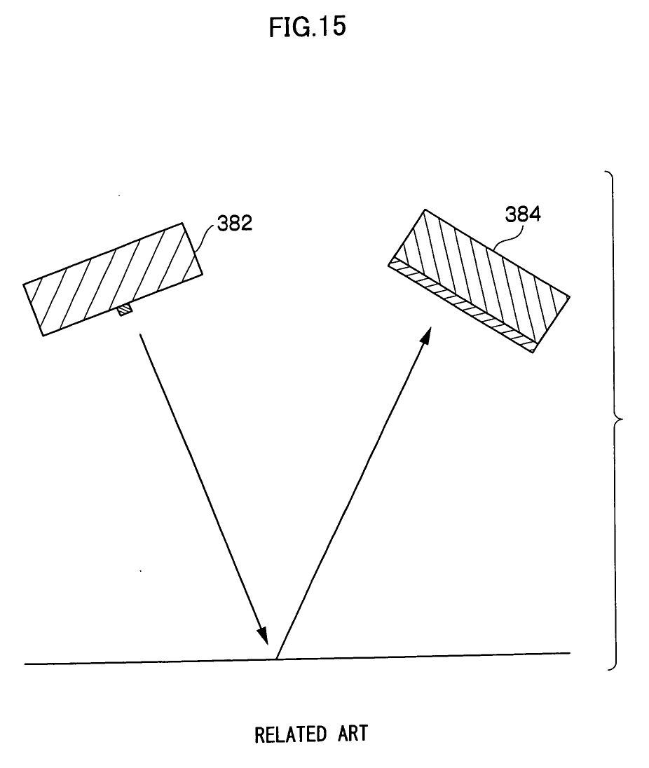

Conventionally, as shown in FIG. 15, a light-emitting unit 382 and a light-receiving unit 384 were separate, and therefore, it was difficult to achieve compactness. Further, aligning of each of the light-emitting unit 382 and the light-receiving unit 384 was required.

In contrast, in this exemplary embodiment, as shown in FIG. 12, at the light transmitting/receiving element 210, the planar light-receiving element 218 is provided above the surface light-emitting element 216, and is integral therewith. Therefore, the structure can be made markedly more compact than that of the conventional art. Further, there is no need to align the surface light-emitting element 216 and the light-receiving element 218.

Modified examples of the light transmitting/receiving elements 10, 210, which are used in the bidirectional light transmitting/receiving systems 100, 200 of the first and second exemplary embodiments and in the optical sensor 300, will be described next.

First, a first modified example will be described.

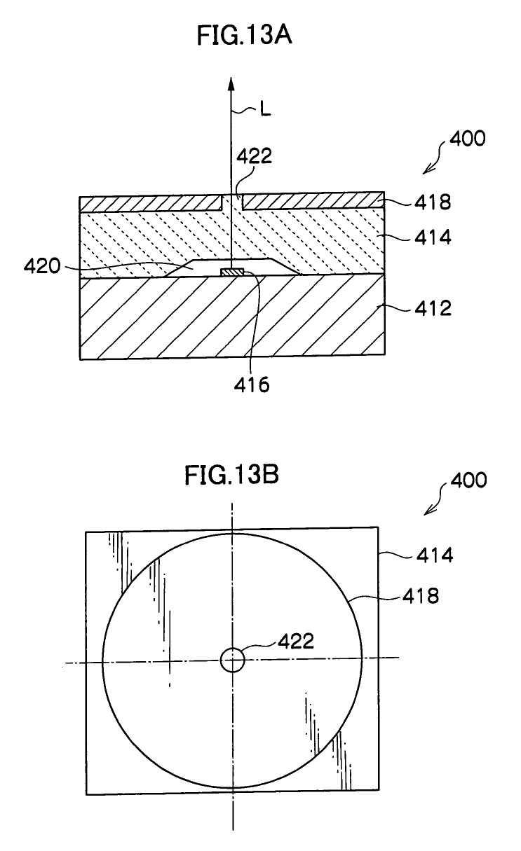

As shown in FIGS. 13A and 13B, a light transmitting/receiving element 400 of a first modified example is structured such that a first base member 412, on whose top surface a surface light-emitting element 416 is formed, and a second base member 414, on whose top surface a planar light-receiving element 418 is formed, are laminated and joined together. A recess 420, in which the surface light-emitting element 416 is accommodated, is formed in the second base member 414.

The second base member 414 is formed of a transparent resin through which the laser light L is transmitted. The laser light L, which the surface light-emitting element 416 emits, passes through the second base member 414 which is formed from a transparent resin, and exits from an exiting window 422.

Operation of the first modified example will be described next.

With such a structure, there is no need to form a cavity in the second base member 414. Accordingly, manufacturing is easier.

A second modified example will be described next.

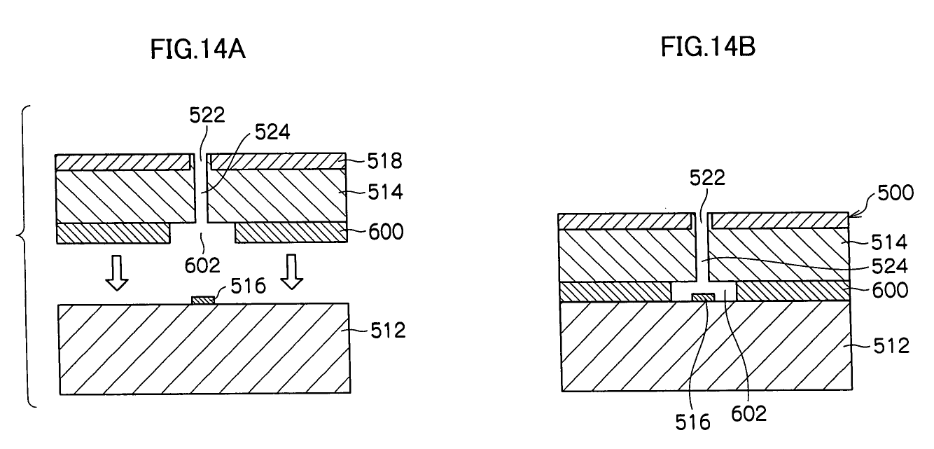

As shown in FIG. 14, in a light transmitting/receiving element 500 of a second modified example, an intermediate base member 600 is sandwiched between a first base member 512 and a second base member 514. A hole 602, in which a surface light-emitting element 516 is accommodated, is formed in the intermediate base member 600. A cavity 524 is formed in the second base member 514, and an exiting window 522 is formed in a planar light-receiving element 518. The intermediate base member 600 is formed of polyimide.

As shown in FIG. 14A, the intermediate base member 600 is formed as a film on the bottom surface of the second base member 514, and the hole 602 is formed by etching. Then, this structured is joined with the first base member 512. Note that it is also possible to use a method in which, initially, the intermediate base member 600 in which the hole 602 is formed is produced, and this intermediate base member 600 is joined to the first base member 512 or to the second base member 514, and thereafter, the two are laminated and joined together.

Operation of the second modified example will be described next.

With such a structure, there is no need to form a recess in the second base member 514. Accordingly, manufacturing is easier.

Note that the present invention is not limited to the above-described exemplary embodiments.

For example, the above exemplary embodiments are a two-layer structure in which a first base member and a second base member are laminated and joined together, or a three-layer structure of a first base member, an intermediate base member, and a second base member. However, the present invention is not limited to the same, and may be a structure of four layers or more in which four or more base members are laminated and joined together.

What is claimed is:

1. A light transmitting and receiving element comprising:
a first base member on whose top surface a surface light-emitting element is formed;
a second base member which is provided on the first base member, and on whose top surface a light-receiving element is formed;
an exiting window which is provided at the light-receiving element, and from which light, which the surface light-emitting element emits, exits; and
a transmitting portion provided between the exiting window and the surface light-emitting element, the light passing through the transmitting portion.

2. The light transmitting and receiving element of claim 1, wherein the transmitting portion is a cavity.

3. The light transmitting and receiving element of claim 1, wherein the transmitting portion is formed of a material through which light passes.

4. The light transmitting and receiving element of claim 1, wherein
the top surface of the first base member and a bottom surface of the second base member are joined together, and
a recess, in which the surface light-emitting element is accommodated, is provided in the bottom surface of the second base member.

5. The light transmitting and receiving element of claim 1, wherein
an intermediate base member is joined between the first base member and the second base member, and
a hole, in which the surface light-emitting element is accommodated, is formed in the intermediate base member.

6. The light transmitting and receiving element of claim 1, wherein an electrode for external connection of the surface light-emitting element, and an electrode for external connection of the light-receiving element, are formed at a bottom surface of the first base member.

7. The light transmitting and receiving element of claim 6, wherein
there are at least three of the electrodes for external connection which are formed at the bottom surface of the first base member, and
a center of the light transmitting and receiving element is at an inner side of a region surrounded by the electrodes.

8. A bidirectional light transmitting and receiving system comprising:
a light guiding member; and
a pair of light transmitting and receiving elements mounted to both ends of the light guiding member,
wherein each of the pair of light transmitting and receiving elements includes:
a first base member on whose top surface a surface light-emitting element is formed;
a second base member which is provided on the first base member, and on whose top surface a light-receiving element is formed;
an exiting window which is provided at the light-receiving element, and from which light, which the surface light-emitting element emits, exits; and
a transmitting portion provided between the exiting window and the surface light-emitting element, the light passing through the transmitting portion.

9. The bidirectional light transmitting and receiving system of claim 8, wherein the light guiding member is one of an optical fiber and an optical waveguide.

10. The bidirectional light transmitting and receiving system of claim 8, wherein a peak position of an intensity distribution at the light-receiving element of light guided through the light guiding member, and a position of the exiting window, are offset from one another.

11. The bidirectional light transmitting and receiving system of claim 10, wherein
a refractive index of a cross-section of the light guiding member is asymmetrical with respect to a central position, and
the exiting window is at a central position of the light-receiving element.

12. The bidirectional light transmitting and receiving system of claim 10, wherein
a refractive index of a cross-section of the light guiding member is substantially uniform, and
the exiting window is disposed so as to be offset from a central position of the light-receiving element.

13. The bidirectional light transmitting and receiving system of claim 8, wherein projecting portions, which are inserted into the exiting windows of the light transmitting and receiving elements, are formed at distal end portions of the light guiding member.

14. The bidirectional light transmitting and receiving system of claim 8, wherein
a wavelength of light emitted by the surface light-emitting element of the light transmitting and receiving element, and a wavelength of light which can be received by the light-receiving element, are different,
a wavelength of light emitted by the surface light-emitting element of the light transmitting and receiving element mounted to one end portion of the light guiding member, and a wavelength of light received by the light-receiving element of the light transmitting and receiving element mounted to another end portion of the light guiding member, are the sane, and
a wavelength of light emitted by the surface light-emitting element of the light transmitting and receiving element mounted to the other end portion of the light guiding member, and a wavelength of light received by the light-receiving element of the light transmitting and receiving element mounted to the one end portion of the light guiding member, are the same.

15. An optical sensor, wherein
the optical sensor has a light transmitting and receiving element, and
the light transmitting and receiving element includes:
a first base member on whose top surface a surface light-emitting element is formed;
a second base member which is provided on the first base member, and on whose top surface a light-receiving element is formed;
an exiting window which is provided at the light-receiving element, and from which light, which the surface light-emitting element emits, exits; and
a transmitting portion provided between the exiting window and the surface light-emitting element, the light passing through the transmitting portion.

16. A light transmitting and receiving element comprising:
a first base member on whose top surface a surface light-emitting element is formed;
a second base member which is provided on the first base member, and on whose top surface a light-receiving element is formed; and
a transmitting portion provided in the second base member, through which light from the surface light-emitting element passes,
wherein the second base member and the light-receiving element are provided above the surface light-emitting element.

17. A light transmitting and receiving element comprising:
a first base member on whose top surface a surface light-emitting element is formed; and
a second base member which is provided on the first base member, and on whose top surface a light-receiving element is formed,
wherein the light-receiving element has an exiting window from which light, which the surface light-emitting element emits, exits.
